(19) United States
(12) Patent Application Publication
(10) Pub. No.: US 2002/0170862 A1
(43) Pub. Date: Nov. 21, 2002

(54) Method of utilizing organic waste

(76) Inventors: Nikolay Vasillievich Rudyuk, Nikolaev (UA); Victor Petrovich Babiy, Nicolaev (UA); Lyudmila Nikolaevna Markina, Nikolaev (UA)

Correspondence Address: ILYA ZBOROVSKY, 6 Schoolhouse Way, Dix Hills, NY, 11746, US

(21) Appl. No.: 10/101,146

(22) Filed: Mar. 19, 2002

(30) Foreign Application Priority Data
Mar. 19, 2001 (UA) 2001031804

(51) Int. Cl. C02F 1/72

(52) U.S. Cl. 210/761

(57) ABSTRACT

It is proposed the method of utilizing organic waste continuously fed to a closed-type reactor, wherein said waste are subjected to pyrolysis resulting in the formation of a steam-and-gas mix and a solid residue, said residue being distributed along the reactor length and withdrawn at the outlet thereof in which due to the possibility of repeated recirculation of heavy liquid fractions interacting with a solid residue in the reactor, it would be possible to achieve a required extent of thermal decomposition of products inside the reactor, and to produce a final product having a preset mass at the reactor outlet. One of the aspect of this invention is provided a method of utilizing organic waste, which would ensure the possibility of utilizing waste having a wide range of initial molecular masses, and to produce from such waste a final liquid product having a preset molecular mass through the automatic control of temperatures in first coolers from generated control signals proportional to deviations of measured molecular masses from the preset value.

### FIELD OF THE INVENTION

This invention relates to waste utilization, and particularly deals with methods of utilizing organic waste, providing pyrolysis of waste within a closed- type reactor, resulting in the formation of a steam-and-gas mix and a solid residue that is distributed along the reactor length and withdrawn at the reactor outlet.

### BACKGROUND OF THE INVENTION

At present, the problem of utilizing organic waste that practically do not decompose under natural conditions, e.g. polymers, rubber etc., has acquired substantial urgency.

From the environmental standpoint, thermal methods of waste utilization involving closed-type reactors appear to be attractive.

Thus, known in the art is a method of utilizing polymer waste, providing primary pyrolysis inside a reactor without any access for air, at a temperature of 400 to 980° C., and resulting in the formation of a primary steam-and-gas mix (SGM) and a solid carbonic residue (SU, A, 1,201,294). This method also comprises subsequent cooling of the steam-and-gas mix, and its separation into constituents in the form of liquid and gaseous fractions. The liquid fraction is then separated, by way of settling, into light hydrocarbons and an aqueous mixture of heavy hydrocarbons, the latter being subsequently used as a wetting liquid. The solid carbonic residue is ground and granulated jointly with the wetting liquid.

This known method may provide the utilization process only in the cyclic mode since separation of the dry solid residue (pyrocarbon) from the bottom portion of the reactor is impossible. Due to the use of a single cooling stage, required depth and level of thermal decomposition of both solid waste and individual heavy constituents of the steam-and-gas mix, having a molecular mass above 1000, cannot be achieved. As a result, output of a liquid fraction having a molecular mass of 100 to 200 and complying with light gasoline fractions, becomes practically impossible. In practice, settling method allows production of up to 4% liquid fraction having a molecular mass of 300 which corresponds to boiler oil.

Besides, the use of the known method does not permit to provide automatic control of temperatures inside coolers, and to use this method e.g. for utilization of organic waste having a wide range of molecular masses of the starting material.

### BRIEF DESCRIPTION OF THE INVENTION

The main object of the present invention is to provide a method of utilizing organic waste in which, due to the possibility of repeated recirculation of heavy liquid fractions interacting with a solid residue in the reactor, it would be possible to achieve a required extent of thermal decomposition of products inside the reactor, and to produce a final product having a preset mass at the reactor outlet.

Another object of the present invention is to provide the possibility of such supply of heavy liquid fractions to the reactor, which would minimize thermal strain of reactor walls, while ensuring conditions for catalytic interaction between said fraction and a solid residue disposed in relevant areas of the reactor, thereby substantially improving process efficiency.

Still another object of the present invention is to provide the possibility of using an optimal number of coolers with account for initial temperatures of the outgoing seam-and-gas mix and cooling temperature in the second (final) cooler.

In addition, an object of the present invention is to provide a method of utilizing organic waste, which would ensure the possibility of utilizing waste having a wide range of initial molecular masses, and to produce from such waste a final liquid product having a preset molecular mass through the automatic control of temperatures in first coolers from generated control signals proportional to deviations of measured molecular masses from the preset value.

These and other objects of the present invention are attained by a method of utilizing organic waste continuously fed to a closed-type reactor, in which said waste are subjected to pyrolysis resulting in the formation of a steam-and-gas mix and a solid residue, said residue being distributed along the reactor length and withdrawn at the outlet thereof, and comprising the following sequence of operations:

a) supplying the steam-and-gas mix produced at the reactor outlet to at least two coolers connected in series and disposed in the order of their temperatures decrease, each first of said coolers serving for selective extraction of a liquid fraction having a molecular mass above the preset value, and each second of said coolers serving for production of a final liquid product, the temperature in each first cooler being preset at the beginning of the process, with account for the initial value of the molecular mass of the waste to be utilized;

b) returning the extracted liquid fraction having a molecular mass above the preset value back into said reactor from each first cooler, ensuring the interaction between said fraction and solid residue in the process of repeated pyrolysis, and producing a steam-and-gas mix having lighter constituents;

c) repeating stages (a) and (b) till attainment of the required degree of thermal decomposition of products inside the reactor, and thereby producing a final liquid product having the preset molecular mass.

When implementing the inventive method for utilizing organic waste having a wide range of initial molecular masses, it is recommended to carry out on-line measurements of the molecular mass of the outgoing liquid product, and to control the temperature in each first cooler depending on deviations of the measured values from the preset values of molecular mass of the final product.

Here, it is expedient to return the liquid fraction having a molecular mass above the preset value from each first cooler to the reactor area whose temperature is substantially at the level of a temperature of the liquid fraction returned, thereby ensuring an optimal mode of thermal impact on reactor walls. In addition, such return can be provided to the reactor area whose temperature is slightly below a temperature of the liquid fraction returned, thereby ensuring catalytic interaction between the above liquid fraction and the solid residue disposed in this area, and resulting in an increase in the intensity and efficiency of the pyrolysis process and a decrease in the multiplicity of repetition of stages (a) and (b).

According to the invention, the optimal number of coolers can be determined from the formula:

$$N = \frac{{t}_{1} - {t}_{2}}{( 70 \div 100 ) °C .}$$

where

t₁ is the initial temperature, of the primary steam-and-gas mix;

t₂ is the cooling temperature in the second cooler.

In the inventive method, it is preferable to select the preset values of molecular masses of the final liquid product within the range of 100 to 200, and more preferably from 120 to 170.

Here, in the course of temperature control in first coolers, it would be expedient to carry out decrease/increase of temperatures versus rated values within the range of 30° C. to 60° C., and preferably from 40° C. to 50° C.

Such embodiment of the inventive method permits effective initiation of the pyrolysis process and attainment of deep level of waste decomposition, particularly in case of hazardous waste, and thermal destruction of such waste without any release of its products into environment. The method also permits to obtain a rather high percentage of output (up to 85%) of the final product in the form of a liquid fuel that can be used either in explosion engines or as boiler oil. In addition, the inventive method provides the possibility of controlling the extent of decomposition of initial organic waste having a wide range of molecular masses, thereby allowing the process of producing a liquid fuel with preset characteristics to be stabilized, while ensuring a high productive capacity of such process.

### BRIEF DESCRIPTION OF DRAWINGS

The invention is further described in more detail in terms of various embodiments of the inventive method, given with reference to the accompanying drawings, in which:

FIG. 1 is a block diagram of the device for carrying out one preferred embodiment of the inventive method;

FIG. 2 is a block diagram of the device for carrying out another preferred embodiment of the invention, providing the possibility of automatically controlling temperatures in coolers depending on deviations of measured values of molecular masses of the outgoing liquid product from preset values;

FIG. 3 is a diagram illustrating variations of molecular masses of initial organic waste in the process of primary pyrolysis, in the course of increasing destruction depth (increasing mass percentage of volatile constituents in the steam-and-gas mix);

FIG. 4 is a diagram demonstrating molecular mass variations in the course of returning liquid fractions withdrawn from three first coolers, connected in series, back to the reactor.

### PREFERRED EMBODIMENT OF THE INVENTION

To illustrate a specific example of embodiment of the inventive method, organic waste to be utilized were selected to comprise equal amounts of polymers, rubber, wood, and textile, although for those skilled in the art it is clear that any other organic waste or mixes thereof can be used. Generally, the maximum temperature in the reactor for each type of waste, as well as the starting temperature of the primary steam-and-gas mix are set empirically. Thus, for the above waste, the maximum reactor temperature amounts to about 800° C., and the starting temperature of the primary steam-and-gas mix, to about 450° C. In compliance with the inventive method, the steam-and-gas mix is supplied to at least first and second coolers disposed in the order of decrease in temperatures thereof. In accordance with a preferred embodiment of the invention, the total number of coolers can be calculated from the formula:

$$N = \frac{{t}_{1} - {t}_{2}}{( 70 \div 100 ) °C .}$$

where

t₁ is the initial temperature of the primary steam-and-gas mix;

t₂ is the cooling temperature in the second cooler.

Taking into account that the last (second) in a series of coolers is intended for producing a final liquid product, in practice the cooling temperature for this cooler is about 50° C. Considering the data available, the total number of coolers required for utilizing the above type of waste must be 4. Since temperature decrease is expedient to be a multiple of 70-100, cooling temperatures in first three coolers can be selected as follows:

| | |
|---|---|
| temperature of the first stage: | 450 − 100 = 350° C.; |
| temperature of the second stage: | 350 − 100 = 250° C.; |
| temperature of the third stage: | 250 − 100 = 150° C. |

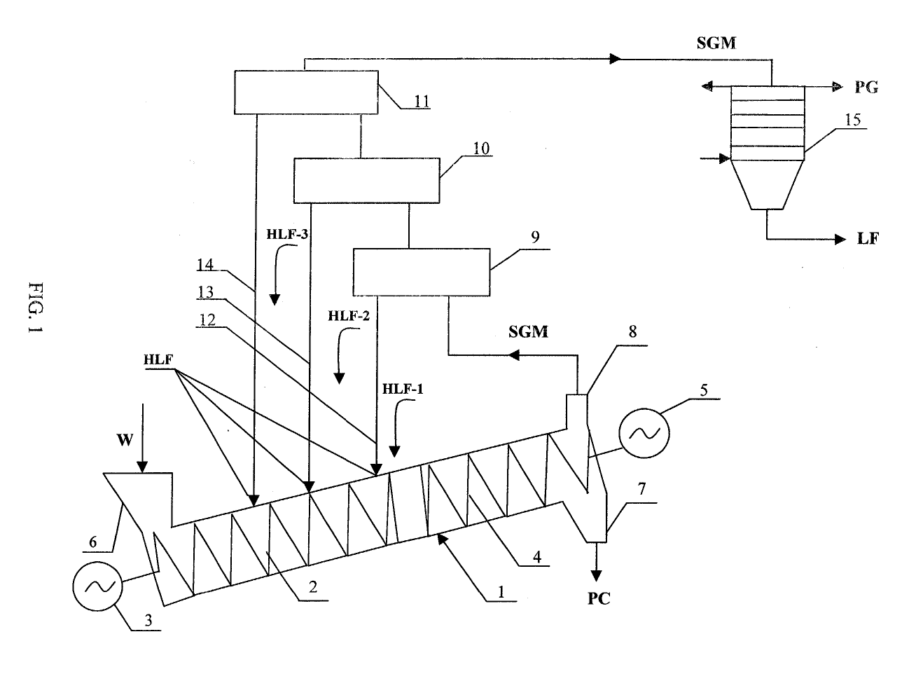

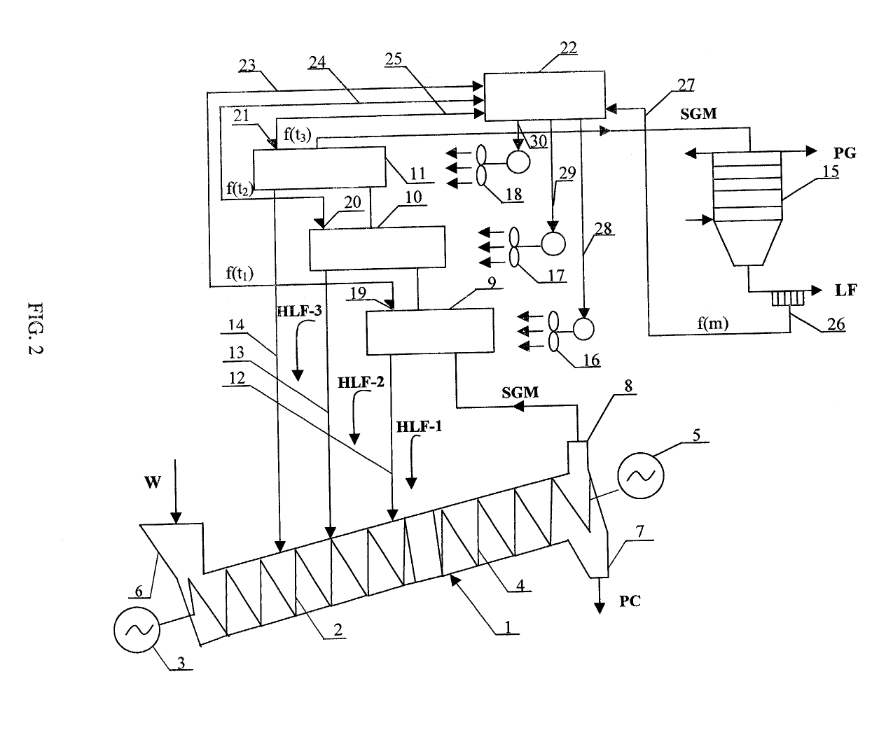

The device for carrying out the inventive method, implementing a four-stage temperature decrease with the use of four coolers (three first coolers and one second cooler) is shown in FIG. 1. This device comprises reactor 1 which is preferably fastened at some angle to ensure the possibility of gravity flow of liquid fractions. The device comprises screw member 2 provided with electric drive 3, intended for mixing the waste inside reactor 1, and screw member 4 provided with electric drive 5, intended for withdrawing the solid residue. Accordingly, provided in the device are bin 6 for waste supply, bin 7 for withdrawal of solid residue (pyrocarbon), and branch pipe 8 for removal of SGM that is delivered to three first coolers connected in series, and namely coolers 9, 10, 11 which are connected to reactor 1 by means of respective pipelines 12, 13, 14. Last cooler 11 is connected to second cooler 15, being a discharge condenser that is water-cooled and provided with branch pipes for discharging pyrolysis gas (PG) and liquid fuel (LF).

Ground organic waste (W) are loaded into bin 6, and then to reactor 1 where without any access for air, and at a preferred temperature of 400 to 980° C., primary pyrolysis takes place, resulting in the formation of a multi-component steam-and-gas mix (SGM) and a solid carbonic residue. The resulting steam-and-gas mix is removed from reactor 1 through branch pipe 8, and cooled in coolers 9, 10, and 11 with temperature drop across each subsequent cooler, using temperature values 350° C., 250° C., and 150° C. In cooler 9, the first heavy liquid fraction (HLF) containing the heaviest constituents having a high boiling point is condensed; these constituents have not completely passed the destruction stage and have a molecular mass far above the preset one. The resulting heavy liquid fraction (HLF-1) is supplied through pipeline 12 to the reactor, to the waste temperature level equal to the temperature of the liquid fraction (350° C.). The remaining, lighter portion of SGM, is supplied to cooler 10 having a temperature of 250° C., where the second fraction, HLF-2, is produced, lighter than in cooler 9 but yet not complying with specifications of the final liquid product. HLF-2 is supplied to reactor 1 through pipeline 13, preferably to the waste temperature level of 250° C. The remaining, still lighter SGM, is supplied to the next cooler having a temperature of 150° C. The resulting HLF-3 is also returned through pipeline 14 back to reactor 1, to the waste temperature level of 150° C. The light SGM is supplied to discharge condenser 15 that is water-cooled down to a temperature of up to 50° C. Produced at the outlets of this condenser is a final liquid product (liquid fuel) having a preset molecular mass, and pyrolysis gas (PG).

Upon getting of HLF from coolers 9, 10, 11 into reactor 1, pyrolysis would be expedient to carry out in 2 stages. At the first stage, heated solid residue, pyrocarbon, is mixed with HLF with the use of screw member 2 to obtain a uniform mass. As a result, activation energy of HLF constituents in each loop becomes 1.5 to 3 times lower than that of initial waste constituents. Activation energy characterizes the tensile energy of C—C and C—H bonds, and is measured in kcal/mole. Thus, in the uniform mix of waste subjected to pyrolysis, the solid residue plays the role of an initiating element that reduces the total bond tensile energy (activation energy) of both HLF and initial organic waste, e.g. 80-90 kcal/mole on the average, thereby reducing power consumption required for pyrolysis and increasing waste decomposition level.

Following this, at the second stage the solid residue is separated from this mix with the use of screw member 4 provided with drive 5, and the process of pyrolysis is carried out till evaporation, under the effect of temperature, of all liquid and steam-and-gas mix from the total volume of the solid residue, and till the solid residue acquires a porous structure and becomes the carbonic residue, i.e. pyrocarbon (PC).

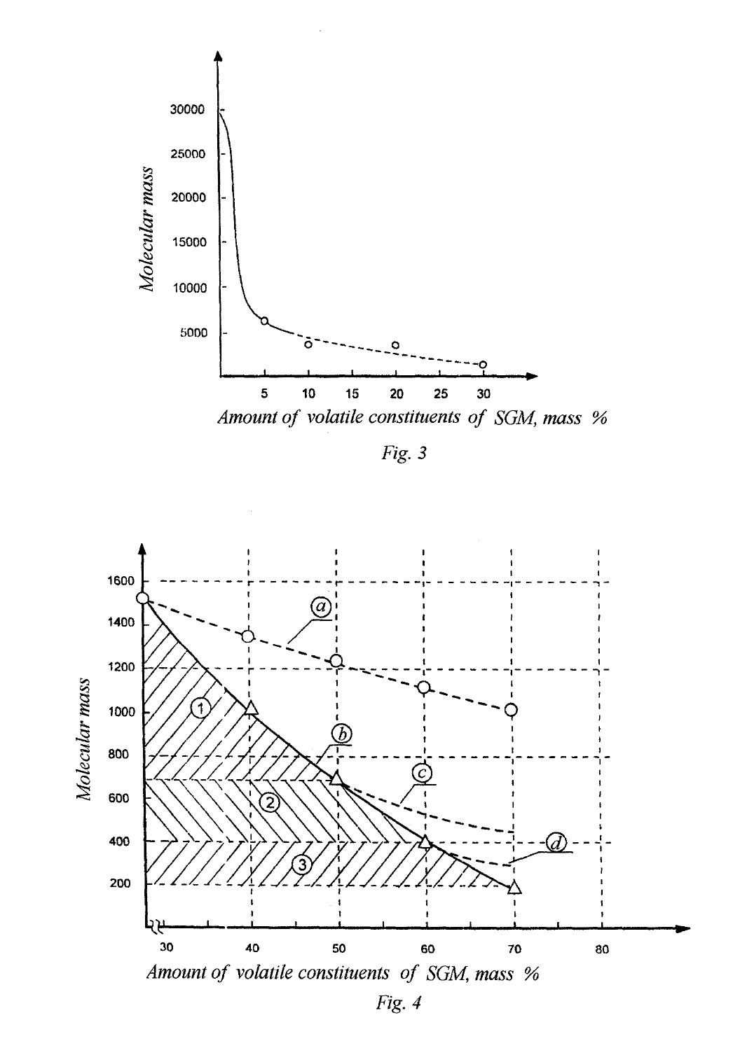

The nature of progress of destruction processes resulting in variation of molecular masses of the final liquid product in accordance with the inventive method can be also explained with reference to FIGS. 3 and 4.

FIG. 3 illustrates the variation of molecular masses of organic domestic waste comprising equal amounts of polymers, rubber, wood, and textile materials, in the process of primary pyrolysis.

In the course of heating various kinds of waste having a wide range of activation energy values, the waste having low activation energy feature an increase in their heat storage and hence intensification of oscillatory, rotary, and translational motion of molecules. In response to temperature increase, each individual molecule manifests itself more or less as an independent particle. Upon having accumulated a sufficient energy, majority of molecules are evaporated without reaching a sufficient degree of decomposition, producing, due to the method known in the art, a primary steam-and-gas mix with heavy constituents whose molecular mass amounts to about 1000 (curve (a) shown in FIG. 4).

In compliance with the proposed method, the above steam-and-gas mix is subjected to successive multistage cooling with temperature decrease at each stage. To this end, the primary steam-and-gas mix produced in reactor 1 is supplied, at a temperature of 450° C., to the first cooling stage (cooler 9) having a temperature of 350° C. Heavy constituents of the primary steam-and-gas mix, having a molecular mass of 700 to 1500, are condensed into HLF-1 and through pipeline 12 are self-flowing into the predetermined area of reactor 1 where the temperature amounts to 350° C.

Secondary steam-and gas mix produced in reactor 1 and formed by supplied HLF-1, is subjected to repeated selective withdrawal of heavy constituents in compliance with the same principle as that applied to the primary steam-and-gas mix. As a result, the process of pyrolysis proceeds in accordance with curve b (FIG. 4) and characterizes the area (1) of single-stage repeated pyrolysis of steam-and-gas mix constituents having a molecular mass of 700÷1500. If only the first cooling stage is used, the further process of pyrolysis will proceed in accordance with curve c, parallel to curve a (FIG. 4). The remaining lighter portion of the SGM is supplied to the second cooling stage (cooler 10) at a temperature of 250° C. SGM constituents having a molecular mass of 700-400 (FIG. 4, area (2)), are condensed into a HLF-2 and self-flow to the predetermined area of reactor 1 at a temperature of 250° C., where they are also subjected to repeated pyrolysis.

The remaining lighter portion of the steam-and-gas mix is supplied to the third cooling stage (cooler 11) at a temperature of 150° C. Steam-and-gas mix constituents having a molecular mass of 400-200 (FIG. 4, area (3)), are condensed into HLF-3 and self-flow to the predetermined area of reactor 1 at a temperature of 150° C., where they are also subjected to repeated pyrolysis.

The remaining conditioned portion of the steam-and-gas mix in which all the constituents have a molecular mass below 200 (FIG. 3), which corresponds to gasoline fraction, is condensed at the fourth cooling stage (second cooler 15 having a cooling temperature about 50° C.), accumulated in the settler, and 18 is supplied to a consumer, as well as remaining fuel gas.

In general form, the inventive process of transforming initial organic waste, R, to an intermediate product of solid residue, S, and then to pyrocarbon, C, and multicomponent aggregate steam-and-gas mix V₁, involving the repeated return of heavy fractions to those reactor areas where their action as initiating agents is ensured, can be presented as follows:

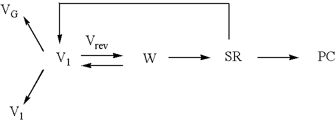

Thus, the proposed method of utilizing solid domestic waste permits to increase the depth and level of decomposition of both solid waste and individual constituents of the steam-and-gas mix, thereby increasing the output of light gasoline fractions up to 85%.

The solid residue produced in compliance with the inventive method comprises semi-coke and can be used as solid stove fuel.

The composition of the final liquid fraction produced in compliance with the inventive method is given below in Table:

| Parameter | Analysis results |
|---|---|
| Aggregate content of paraffin hydrocarbons, mass % | 45 |
| Aggregate content of olefin hydrocarbons, mass % | 29.6 |
| Aggregate content of oxygen-containing hydrocarbons, | 13.0 |
| mass % | |
| Aggregate content of aromatic hydrocarbons, mass % | 6.3 |
| Aggregate content of naphthene hydrocarbons, mass % | 6.1 |
| Hydrogen content, mass % | 12.0 |
| Carbon content, mass % | 86.0 |
| Nitrogen content, mass % | 0.8 |
| Oxygen content, mass % | 2.1 |
| Average molecular mass | 161.5 |

The outgoing gaseous fraction substantially comprises a pyrolysis fuel gas generally consisting of methane, CH₄, 74.5%; ethane, C₂H₆, 3.2%; ethylene, C₂H₄, 4.56%, propylene, C₂H₆, 4%, and other combustible constituents; on the whole, its characteristics can be compared with the natural gas.

The inventive method described with reference to FIGS. 1, 3 and 4 provides a high degree of thermal decomposition of organic waste having rather high values of molecular mass, i.e. 100,000 and more.

In utilization of individual batches of waste having moderate molecular masses, there occurs so-called “burning” of starting products. This happens because in utilization of waste having a molecular mass e.g. 10,000, while using the device with the above number of loops and their temperatures, the degree of thermal decomposition is far above the required one. This in turn results in the occurrence, in the fuel, of a great amount of solid carbon particles which clog injectors during the use of such fuel e.g. in explosion engines.

In compliance with another aspect of the present invention, proposed is another preferred modification of the inventive method, permitting utilization of waste having a wide range of initial values of molecular masses. To this end, carried out are online measurements of the molecular mass of the outgoing liquid product at the second cooler outlet, and the temperature in each first cooler is controlled depending on a deviation of the measured value from the preset value of molecular mass of the final liquid product.

Possible embodiment of the device that permits to implement such method is shown in FIG. 4.

In contrast to the device shown in FIG. 1, coolers 9, 10, and 11 are provided with corresponding fans 16, 17, and 18 with a control input.

Coolers 9, 10, 11 are also provided with temperature sensors 19, 20, and 21. Parameters of temperature variation function, f(t), are transmitted from each cooler to control unit 22 through links 23, 24, and 25. Indicator 26 fastened at the outlet of cooler 15 is intended for generating a signal proportional to the parameter of molecular mass variation function of the liquid fuel, f(m), and transmitting this signal to control unit 22 through link 27. Signals to control inputs of fans are supplied through links 28, 29, 30.

The principle of operation of indicator 26 is based on periodic variations of viscosity of the initial liquid fuel. The use of viscosimetric method permits to identify an average viscosity value of molecular mass, M, which is expressed by the following formula:

$$M = {[ \frac{\sum {N}_{i} {M}_{i}^{1 + α}}{\sum {N}_{i} {M}_{i}} ]}^{1 / α}$$

where

Nᵢ is the number of molecules having molecular mass Mᵢ;

α is the constant in the Mark-Houwink equation, |η|=KM², which identifies the dependence between intrinsic viscosity, |η|, and molecular mass, M, of the outgoing liquid product.

In other words, operation of indicator 26 is based on the principle of proportional dependence of liquid viscosity on molecular mass, |η|=M, at a given temperature.

In case of producing an initial liquid fraction having a molecular mass of M>150, indicator 26 generates f(m) signal to control unit 22 for increasing the voltage across fan 16 drive, thereby increasing its speed and blasting velocity. As a result, cooling temperature in cooler 9 temperature drops from design value, 350° C., e.g. down to 300° C. In this case, the amount of HLF-1 withdrawn from the first loop will increase, and hence the degree of decomposition of HLF-1 and other pyrolysis products increases.

If in so doing the value of M>150 does not change, then the control unit increases the voltage across fan 17 drive, thereby reducing the temperature in cooler 10 from 250° C. down to 200° C. Here, the amount of HLF-2 withdrawn from the second loop, also increases, and hence the degree of decomposition of pyrolysis products increases.

If such action fails to change the M>150 ratio, then a similar procedure is used for reducing the temperature in cooler 11 from 150° C. down to 100° C.

In this case, the amount of HLF-3 withdrawn from the third loop also increases, thereby upgrading the degree of decomposition of pyrolysis products. Each of coolers 9, 10, 11 is equipped with temperature sensor 19, 20, 21, respectively, that perform measurements of cooler temperature and generate signals f(t₁), f(t₂), f(t₃) through links 23, 24, 25 to control unit 22 which comprises a temperature feedback intended for adjusting the rotation frequency of a corresponding fan in the air-cooling system of coolers. This is sufficient for changing the M>150 ratio in case of maximum values of waste molecular masses, which fact has been confirmed in the process of operation.

In case of producing a liquid fraction having M<1 50, indicator 26 generates a relevant signal, f(m), to control unit 22, which reduces the voltage across the fan drive, starting from fan 18, thereby reducing its rotation frequency. As a result, intensity of cooler 11 blasting is reduced, while the temperature is increased from 150° C. up to 200° C. In this case, the amount of HLF-3 withdrawn from the third loop decreases, and hence the level of decomposition of pyrolysis products reduces. If the condition M<150 does not change, then control unit 22 carries out successive increase of temperature in cooler 10 (from 250° C. up to 300° C.), and in cooler 9 (from 350° C. up to 400° C.), similarly decreasing the level of decomposition of pyrolysis products.

In case where such actions fail to change the value of M<150, the number of loops is reduced by equalizing temperatures in adjacent loops that are the closest to the discharging (second) cooler 15. Here, rotation frequency of fan 17 is reduced to cause a gradual temperature increase in cooler 10 up to 400° C. (the same as in the first cooler); as a result, coolers 9 and 10 will perform the function of a single cooling loop. Correspondingly, the total amount of heavy liquid fraction withdrawn from both loops will be equal to the amount of liquid withdrawn from the first loop etc. Hence, the level of decomposition of pyrolysis products will be substantially reduced.

Thus, the inventive method will permit to control the degree of thermal decomposition of initial organic waste having a wide range of molecular masses, and to ensure stable production of a liquid fuel having an optimal molecular mass of 100 to 200, thereby ensuring a decrease in energy consumption, an increase in the efficiency of the method, and production of a quality liquid fuel for explosion engines.

1. A method of utilizing organic waste continuously fed to a closed-type reactor, wherein said waste are subjected to pyrolysis resulting in the formation of a steam-and-gas mix and a solid residue, said residue being distributed along the reactor length and withdrawn at the outlet thereof, comprising the following stages:
a) supplying the steam-and-gas mix produced at reactor outlet to at least two coolers connected in series and disposed in the order of temperature decrease, first of said coolers serving for selective withdrawal of a liquid fraction having a molecular mass above the preset value, and second of said coolers serving for production of a final liquid product, the temperature in each first cooler being preset at the beginning of the process, proceeding from the initial value of molecular mass of the waste to be utilized;
b) returning the withdrawn liquid fraction having a molecular mass above the preset value back into said reactor from each first cooler, ensuring the interaction between heavy fractions and said solid residue in the process of repeated pyrolysis, and producing, at the reactor outlet, a steam-and-gas mix with lighter constituents;
c) repeating stages (a) and (b) till attainment of the required degree of thermal decomposition of products inside the reactor, and thereby producing a final liquid product having the preset molecular mass.

2. The method as set forth in claim 1, wherein the return of said liquid fraction having a molecular mass above the preset value from each first cooler is carried out to the reactor area whose temperature is substantially at the level of a temperature of the returned liquid fraction.

3. The method as set forth in claim 1, wherein the return of said liquid fraction having a molecular mass above the preset value from each first cooler is carried out to the reactor area whose temperature is below the temperature of returned liquid fraction, and is substantially at the level of a temperature in the next cooler, thereby ensuring catalytic interaction between said liquid fraction and the solid residue disposed in this area, and thereby resulting in an increase in the intensity of the pyrolysis process and a decrease in the multiplicity of repetition of stages (a) and (b).

4. The method as set forth in claim 1, wherein the number of coolers, N, is determined from the formula:
$$N = \frac{{t}_{1} - {t}_{2}}{( 70 \div 100 ) °C .}$$
where
t₁ is the initial temperature of the primary steam-and-gas mix;
t₂ is the cooling temperature in the second cooler.

5. The method as set forth in claim 4, wherein the preset value of molecular mass of the final liquid product is selected within the range of 100 to 200, and preferably from 120 to 170.

6. A method of utilizing organic waste continuously fed into a closed-type reactor, in which said waste having a wide range of molecular masses are subjected to pyrolysis resulting in the formation of a steam-and-gas mix and a solid residue, said residue being distributed along the reactor length and withdrawn at the outlet thereof, comprising the following stages:
a) supplying the steam-and-gas mix produced at the reactor outlet to at least two coolers connected in series and disposed in the order of temperature decrease, each first of said coolers serving for selective withdrawal of a liquid fraction having a molecular mass above the preset value, and being provided with a control input intended for temperature control, and second of said coolers serving for production of a final liquid product and for shaping a signal that carries the information on the current value of molecular mass of the outgoing product, the control signal supplied to the control input of each first cooler being shaped proportional to the magnitude of deviation of molecular mass of the outgoing liquid product from the preset value of molecular mass of the final product;
b) returning the withdrawn liquid fraction having a molecular mass above the preset value back into said reactor from each first cooler, ensuring the interaction between said fraction and said solid residue in the process of repeated pyrolysis, and producing a steam-and-gas mix with lighter constituents;
c) repeating stages (a) and (b) till attainment of the required degree of thermal decomposition of products inside the reactor, and thereby producing a final liquid product having the preset molecular mass.

7. The method as set forth in claim 6, wherein the return of the liquid fraction having a molecular mass above the preset value from each first cooler is carried out to the reactor area whose temperature is substantially at the level of the temperature of the returned liquid fraction.

8. The method as set forth in claim 6, wherein the return of the liquid fraction having a molecular mass above the preset value from each first cooler is carried out to the reactor area whose temperature is below the temperature of the returned liquid fraction and is substantially at the level of the temperature of the next cooler, thereby ensuring catalytic interaction between said liquid fraction and the solid residue disposed in this area, and thereby resulting in an increase in the intensity of the pyrolysis process and a decrease in the multiplicity of repetition of stages (a) and (b).

9. The method as set forth in claim 6, wherein the number of coolers, N, is determined from the formula:
$$N = \frac{{t}_{1} - {t}_{2}}{( 70 \div 100 ) °C .}$$
where
t₁ is the initial temperature of the primary steam-and-gas mix;
t₂ is the cooling temperature in the second cooler.

10. The method as set forth in claim 6, wherein the preset value of the molecular mass is selected within the range of 100 to 200, and preferably from 120 to 170.

11. The method as set forth in claim 10, wherein during the production, at the outlet of said second cooler, of said liquid product having the molecular mass above the preset value, the temperature in each first cooler, beginning from the cooler connected to the reactor outlet, is decreased to within 30-60° C., and preferably to 40-50° C.

12. The method as set forth in claim 10, wherein during the production, at the outlet of said second cooler, of said liquid product having the molecular mass below the preset value, the temperature in each first cooler, beginning from the last one, is increased to within 30-60° C., and preferably to 40-50° C.

13. The method as set forth in claim 10, wherein during the production, at the outlet of said second cooler, of said liquid product having the molecular mass below the preset value, the temperatures in at least two adjacent first coolers are equalized, beginning from the cooler connected to second cooler, thereby ensuring a decrease in the number of cooling stages and resulting in an increase of the molecular mass of the final liquid product.
